(19) United States
(12) Patent Application Publication
(10) Pub. No.: US 2007/0194488 A1
(43) Pub. Date: Aug. 23, 2007

(54) Multicolored resin molding apparatus and multicolor molding method

(75) Inventors: Shigekazu Akahoshi, Aichi-ken (JP); Katsumi Tanaka, Aichi-ken (JP); Shinjiro Tomida, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/702,501

(22) Filed: Feb. 6, 2007

(30) Foreign Application Priority Data
Feb. 21, 2006 (JP) 2006-044313

(51) Int. Cl. B29C 45/00

(52) U.S. Cl. 264/255; 264/328.8; 425/112; 425/542

(57) ABSTRACT

In a multicolored resin molding apparatus, a primary molding is molded while a cavity core having a die surface is held by and between dies provided in a primary molding station, and a secondary molding is molded while the cavity core having the primary molding is held by and between dies provided in a secondary molding station. Further, the cavity core having the primary and secondary moldings is delivered to a die removing station, where a molded product is removed from the dies. Since the cavity core is delivered to the respective stations, there is eliminated the need for use of a large-sized and complicated molding machine and, instead of this, a simple general-purpose molding machine can be used.

### BACKGROUND OF THE INVENTION

1. Field of the Invention

The present invention relates to a multicolored resin molding apparatus for use mainly in injection molding and a multicolor molding method using such multicolored resin molding apparatus.

2. Related Art

A part such as a breather nipple, which is connected by welding to a fuel tank made of resin, is composed of an outer layer made of denatured polyethylene excellent in welding property and an inner layer made of polyamide excellent in fuel transmission resistance and is manufactured according to a two color molding method.

The two color molding method is a method which firstly molds a primary molding from a first resin and then molds a secondary molding while the primary molding is disposed within dies; and, as the two color molding method, there are known various methods. For example, as disclosed in the Japanese patent publication H04-296520A, a primary molding is removed from a die and is then disposed in another die and, in this state, there is molded a secondary molding. However, in this method, there is found a problem that, in some cases, because the primary molding is drawn out from the die, the primary molding can be cooled and thus the connecting strength of the primary molding with respect to the secondary molding can be lowered. Also, there is found another problem that the primary molding can be damaged or, owing to the molding compression thereof, there can occur clearances therein to thereby cause burrs therein.

In view of the above problems, for example, as disclosed in the Japanese patent publication H09-277305A, generally, there is used a method which replaces a fixed die while a primary molding remains held in a movable die and then molds a secondary molding. In this case, the replacement of the fixed die is carried out by sliding and moving the movable die; and thus, this method is referred to as a die slide method.

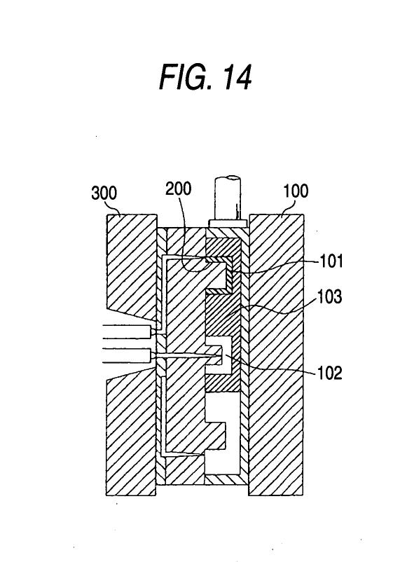

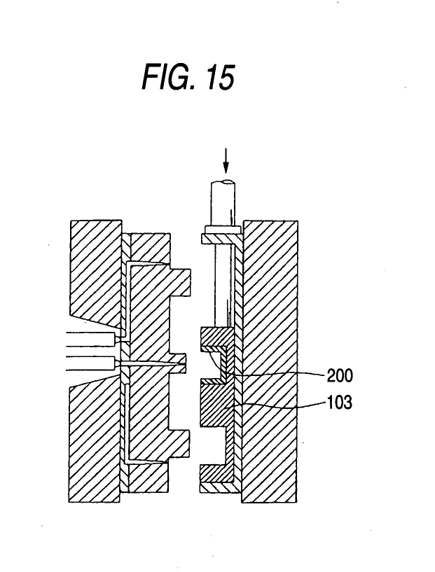

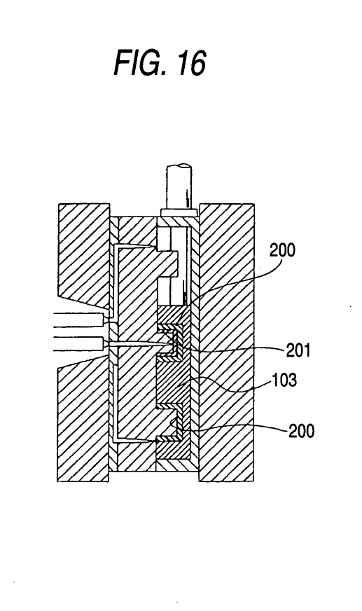

According to this die slide method, for example, as shown in FIGS. 14-18, an intermediate plate 103 having a first cavity 101 and a second cavity 102 is slidably disposed within a movable die 100 and, firstly, a primary molding 200 is molded in the first cavity 101. Next, the movable die 100 is removed from a fixed die 300 and then, as shown in FIG. 15, in a state where the primary molding 200 is disposed within the first cavity 101, the intermediate plate 103 is slided downward in FIG. 15; and, after then, the dies are fastened together again to return to a state shown in FIG. 16. And, in the first cavity 101, a secondary molding 201 is molded on the surface of the primary molding 200 and, at the same time, another primary molding 200 is molded in the second cavity 102.

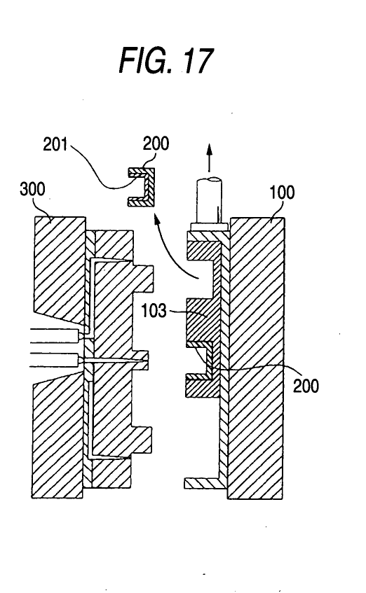

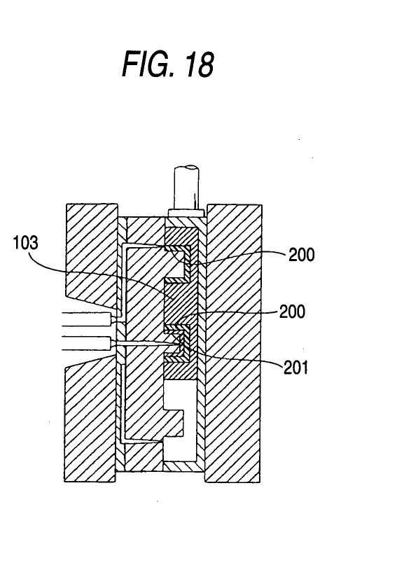

The movable die 100 is removed from the fixed die 300 again and, as shown in FIG. 17, a molded product, which is composed of the primary molding 200 and secondary molding 201 connected together, is drawn out from the first cavity 101. And, the intermediate plate 103 is slided upward in FIG. 17. After then, as shown in FIG. 18, a second molding 201 is molded on the surface of the primary molding 200 in the second cavity 102 and, at the same time, another primary molding 200 is molded in the first cavity 101 which has been emptied.

Therefore, according to the above die slide method, by using the two cavities 101 and 102 alternately, a two color molding can be carried out consecutively, resulting in the excellent productivity.

By the way, since the movable die 100 and fixed die 300 or intermediate plate 103 include a heater for controlling the temperature, a cooling water passage and the like, they are inevitably complicated in structure, which results in a large-sized molding apparatus. Because of the complicated structure as well as because of the lowered rigidity of the dies caused by the complicated structure, there is found a problem that burrs can be produced on the split surfaces of the dies.

Also, as can be understood from the above-mentioned figures, because the runner portion of the molding apparatus are long in length, there arises a problem that the yield rate of the molding material is poor. Further, there is necessary a specific molding machine which includes two injection cylinders, which raises a problem that the installation cost of the molding apparatus is high and the number of steps for the maintenance thereof is large.

### SUMMARY OF THE INVENTION

The present invention is made in view of the above-mentioned circumstances of the related art and thus the invention aims at reducing the production cost of a molding apparatus without reducing the productivity thereof as well as at preventing the occurrence of burrs.

In order to solve the above-mentioned problems, according to the invention, there is provided a multicolored resin molding apparatus, which includes: a primary molding station including a first movable die and a first fixed die, and holding a cavity core having a die surface between the die surface of the movable die and the die surface of the fixed die, for molding a primary molding in a first cavity formed between at least one of the die surfaces of the first movable and fixed dies and the die surface of the cavity core; a secondary molding station including a second movable die and a second fixed die, and holding the cavity core having the primary molding between the die surface of the second movable die and the die surface of the second fixed die, for molding a secondary molding in a second cavity formed between at least one of the die surfaces of the second movable and fixed dies; a die removing station for drawing out a molded product composed of the primary and secondary moldings from the cavity core; a first delivery device for delivering the cavity core having the primary molding from the first molding station to the secondary molding station; a second delivery device for delivering the cavity core having the molded product from the secondary molding station to the die removing station; and a third delivery device for delivering the cavity core, from which the molded product is drawn out and is thereby emptied, from the die removing station to the primary molding station.

The first delivery device, second delivery device and third delivery device, preferably, may be respectively composed of a robot including a hand capable of holding at least two of the cavity cores.

Also, according to the invention, there is provided a multicolor molding method which, using a multicolored resin molding apparatus according to the invention, molds the primary molding within the first cavity in the primary molding station, delivers the cavity core having the primary molding from the first delivery device to the secondary molding station to mold the secondary molding within the second cavity, and delivers the cavity core having the molded product composed of the primary and secondary moldings from the second delivery device to the die removing station to draw out the molded product from the cavity core.

According to a multicolored resin molding apparatus and a multicolor molding method according to the invention, in the primary molding station, the primary molding is molded in the first cavity formed between at least one of the die surfaces of the first movable and fixed dies and the die surface of the cavity core, and the primary molding is drawn out together with the cavity core and is delivered to the secondary molding station. And, in the secondary molding station, the secondary molding is molded in the second cavity formed between at least one of the die surfaces of the second movable and fixed dies and the surface of the primary molding, and the cavity core having the molded product composed of the primary and secondary moldings is drawn out from the secondary molding station and is delivered to the die removing station. In the die removing station, the molded product is removed from the cavity core and the cavity core, which has been emptied, is delivered again to the primary molding station.

Therefore, according to the invention, there is provided a structure in which the cavity core is moved between the respective stations and, in the primary and secondary molding stations, there are used general-purpose molding machines respectively. This can prevent the die structure from increasing in size and being complicated. Thus, the rigidity of the die can be enhanced and the occurrence of burrs can be prevented.

Also, since the length of the runner portion of the molding apparatus is prevented from increasing, the yield rate of the molding material can be enhanced. Further, because it is not necessary to use a specific molding machine but a simple general-purpose molding machine can be used, the installation cost of the molding apparatus can be reduced and thus the number of steps for the maintenance thereof can also be reduced.

And, since the cavity core including the primary molding is delivered, the primary molding itself is not drawn out. This can prevent the primary molding from cooling, whereby the primary molding can secure good adhering property with respect to the secondary molding.

Also, when, as the first, second and third delivery devices, there is employed a robot having a hand capable of holding at least two cavity cores, three cavity cores can be used in order, thereby being able to secure high productivity.

### DETAILED DESCRIPTION OF THE DRAWINGS

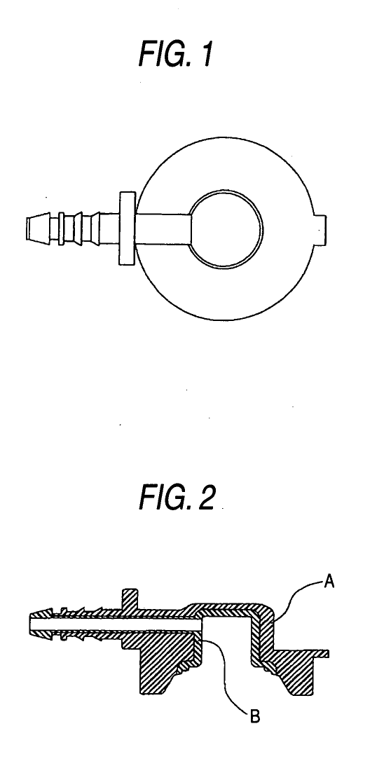

FIG. 1 is a plan view of a molded product molded by a molding apparatus according to an embodiment of the invention.

FIG. 2 is a section view of a molded product molded by a molding apparatus according to an embodiment of the invention.

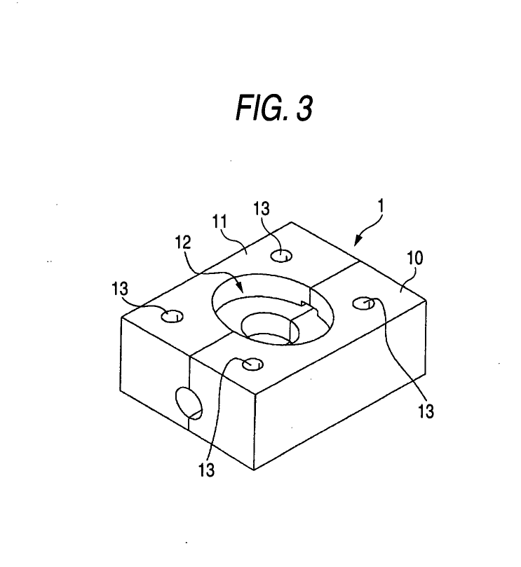

FIG. 3 is a perspective view of a cavity core used in a molding apparatus according to an embodiment of the invention.

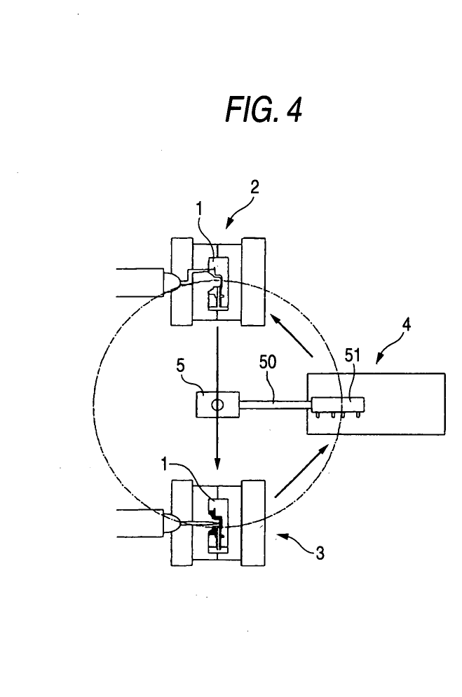

FIG. 4 is a schematic plan view of a molding apparatus according to an embodiment of the invention.

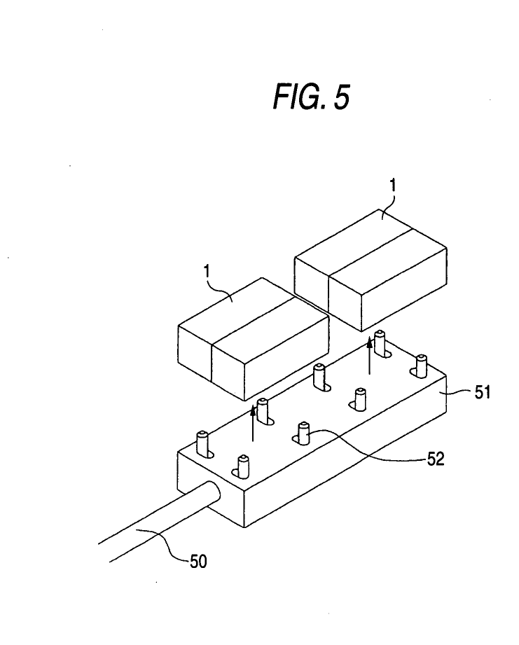

FIG. 5 is a perspective view of a robot hand and a cavity core respectively used in a molding apparatus according to an embodiment of the invention.

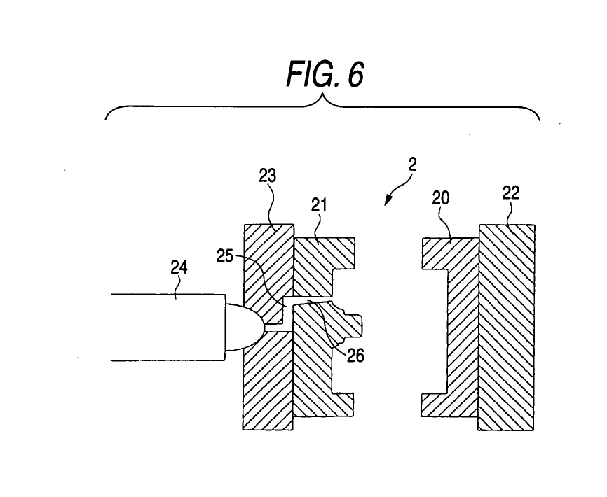

FIG. 6 is a section view of a die used in a primary molding station of a molding apparatus according to an embodiment of the invention, showing a state in which it is opened.

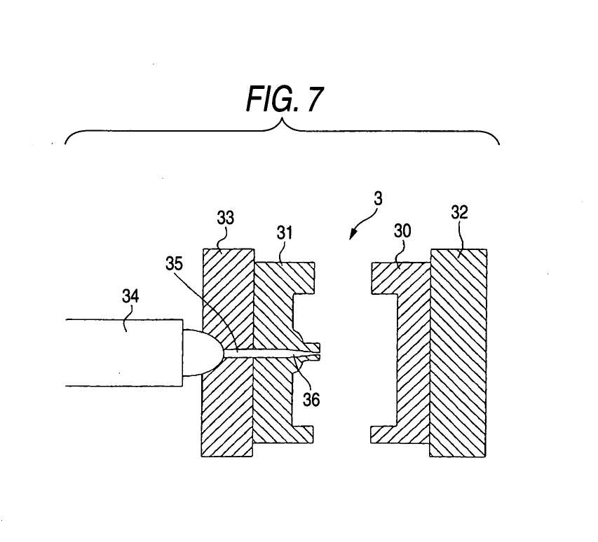

FIG. 7 is a section view of a die used in a secondary molding station of a molding apparatus according to an embodiment of the invention, showing a state in which it is opened.

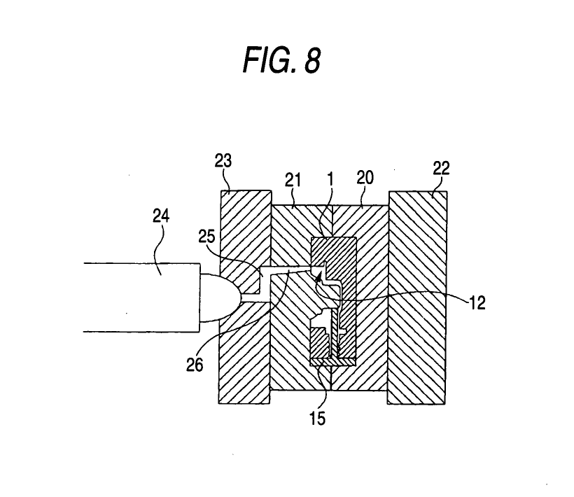

FIG. 8 is a section view of a die used in a primary molding station of a molding apparatus according to an embodiment of the invention, showing a state in which it is fastened.

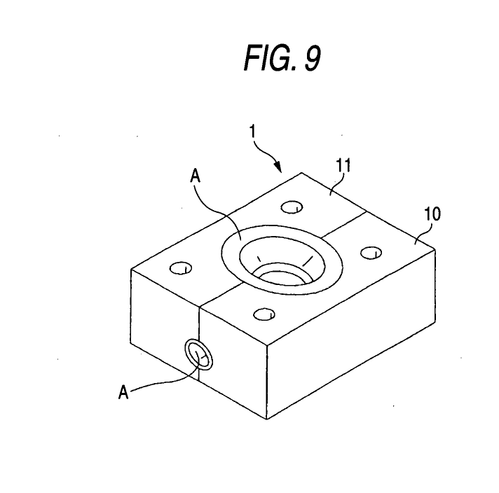

FIG. 9 is a perspective view of a cavity core having a primary molding (A) drawn out in a primary molding station of a molding apparatus according to an embodiment of the invention.

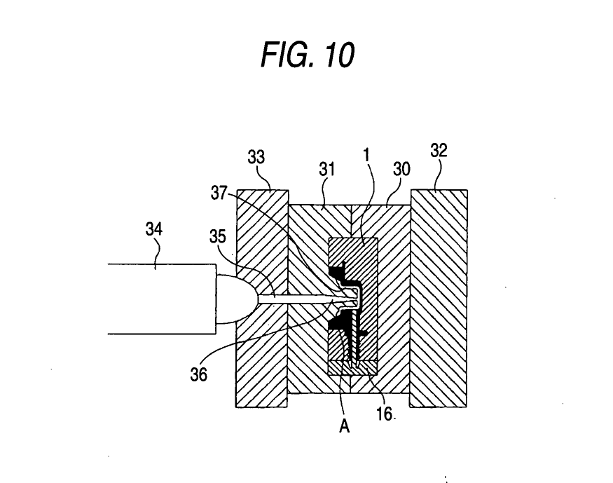

FIG. 10 is a section view of a die used in a secondary molding station of a molding apparatus according to an embodiment of the invention, showing a state in which it is fastened.

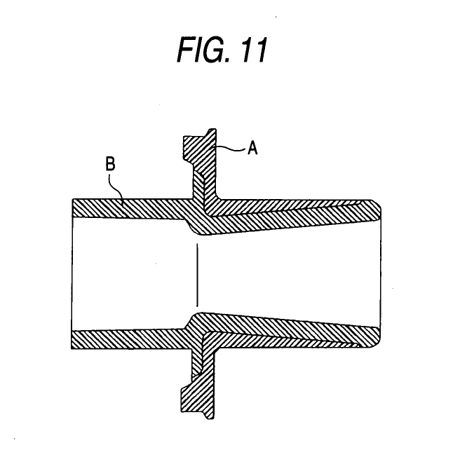

FIG. 11 is a section view of a molded product molded by a molding apparatus according to a second embodiment of the invention.

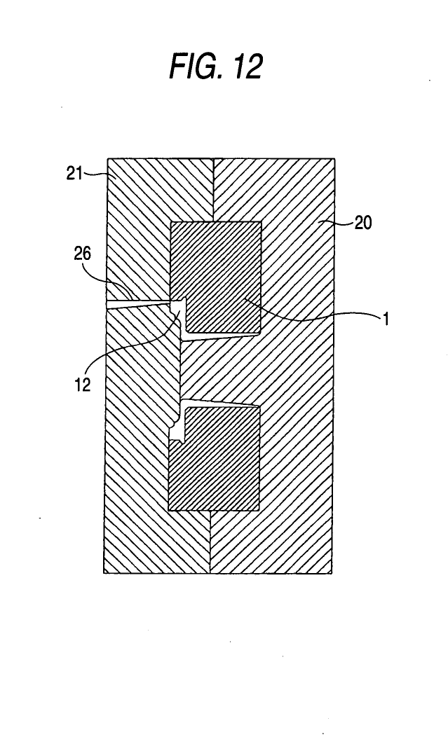

FIG. 12 is a section view of a die used in a primary molding station of a molding apparatus according to a second embodiment of the invention, showing a state in which it is fastened.

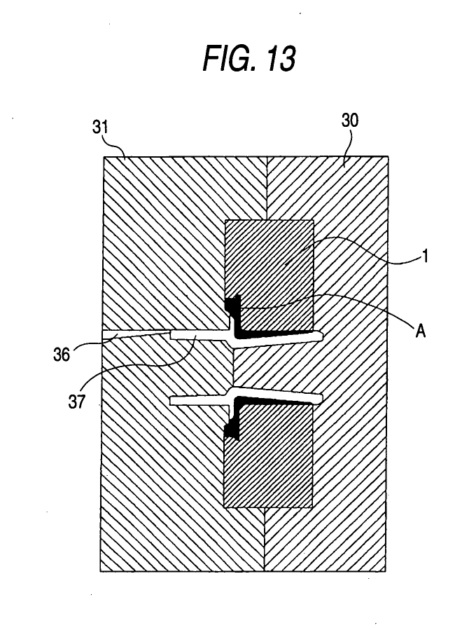

FIG. 13 is a section view of a die used in a secondary molding station of a molding apparatus according to a second embodiment of the invention, showing a state in which it is fastened.

FIG. 14 is a section view of a die used in a conventional die slide method.

FIG. 15 is a section view of a die used in a conventional die slide method.

FIG. 16 is a section view of a die used in a conventional die slide method.

FIG. 17 is a section view of a die used in a conventional die slide method.

FIG. 18 is a section view of a die used in a conventional die slide method.

### DETAILED DESCRIPTION OF THE PREFERRED EMBODIMENTS

In a multicolored resin molding apparatus according to the invention, there are provided a primary molding station, a secondary molding station and a die removing station, while a cavity core having a die surface is delivered to the respective stations by the respective delivery devices.

The primary molding station includes a first movable die and a first fixed die, holds a cavity core between the die surface of the first movable die and the die surface of the fixed die, and molds a primary molding in a first cavity formed between at least one of the die surfaces of the first movable and fixed dies and the die surface of the cavity core.

After completion of the molding operation in the primary molding station, the first movable and fixed dies are opened. And, the cavity core having the primary molding is drawn out from the primary molding station and is delivered to the secondary molding station by the first delivery device.

The secondary molding station includes a second movable die and a second fixed die, holds the cavity core having the primary molding between the die surfaces of the second movable and fixed dies, and molds a secondary molding in a second cavity formed between at least one of the die surfaces of the second movable and fixed dies and the surface of the primary molding.

Since the primary molding is moved together with the cavity core, the area of the primary molding to be exposed to the open air is small and thus the primary molding is difficult to cool. Therefore, when the cavity core having the primary molding is quickly delivered from the primary molding station to the secondary molding station to mold the secondary molding, there can be sufficiently secured high adhering strength between the primary and secondary moldings.

After completion of the molding operation in the secondary molding station, the second movable and fixed dies are opened. And, the cavity core having a molded product composed of the primary and secondary moldings is taken out from the secondary molding station and is then delivered to the die removing station by the second delivery device.

In the die removing station, the molded product composed of the primary and secondary moldings is drawn out from-the cavity core. And, the cavity core, which has been emptied, is delivered to the primary molding station by third delivery device, where a primary molding is molded again.

Since the cavity core generally does not include a heater for controlling the temperature, a cooling water flow passage and the like, the cavity core is simple in structure and is thus easy to deliver. Therefore, the respective delivery devices can be composed of a robot and the number of steps for production thereof can be reduced. Although robots may be disposed in the respective delivery devices one in one, when the respective stations are disposed substantially on the circumference of a circle and a robot is rotatably disposed in the center of the circle, the first, second and third delivery devices can be composed of a robot.

In this case, preferably, the robot may have a hand capable of holding two cavity cores. Thanks to this, as will be described below in connection with embodiments according to the invention, by using three cavities, molding operations can be executed in parallel in the respective molding stations, which can enhance the efficiency of production of the molded product greatly.

Although in the above description there is taken a two color resin molding apparatus, when, between the secondary station and die removing station, there are interposed a tertiary station, a quartic station and the like and there are disposed delivery means for delivering the cavity core to the respective stations, there can be provided a multicolored resin molding apparatus.

### EMBODIMENTS

Now, description will be given below in detail of the invention using the embodiments of the invention.

### Embodiment 1

Now, FIGS. 1 and 2 show a molded product which can be molded using a two color resin molding apparatus according to the present embodiment. This molded product is to be fixed to the outer surface of a resin-made fuel tank by welding; and, the molded product is composed of a primary molding (A) formed of maleic acid denatured polyethylene and a secondary molding (B) made of polyamide and formed integral with the inner peripheral surface of the primary molding (A). The primary molding (A) secures the strength and rigidity of the molded product, while the secondary molding (B) secures the fuel transmission resistance of the molded product.

Also, FIG. 3 shows a perspective view of a cavity core 1 used in the present embodiment. The cavity core 1 is composed of a pair of split dies 10 and 11 and includes a die surface formed between the two split dies to constitute a first cavity 12. In each of the two split dies 10 and 11, there are formed a pair of hold holes 13.

FIG. 4 shows a two color resin molding apparatus according to the present embodiment. This two color resin molding apparatus is composed of a primary molding station 2, a secondary molding station 3 and a die removing station 4, while the respective stations are disposed substantially on the circumference of the same circle. In the center of the same circle, there is provided a robot 5 in such a manner that it can be rotated. On the leading end of a robot arm 50 which extends-from the robot 5, there is mounted a robot-hand 51. This robot hand 51 is positioned substantially on the same circumference as the respective stations.

The robot hand 51, as shown in FIG. 5, includes two sets of projections 52 (each set is composed of four projections) which can be engaged with the four hold holes 13 formed in the cavity core 1. The two sets of projections 52 are structured such that they can be moved in a direction to approach each other and in a direction to part away from each other by a drive device (not shown). After the projections 52 are inserted into the hold holes 13, when they are moved in the mutually approaching direction or in the mutually parting direction, they are able to chuck hold the cavity core 1. That is, since the robot hand 51 can hold one cavity core 1 with one set of (four) projections 52 as well as the other cavity core 1 with the other set of projections 52, the robot hand 51 is able to hold a total of two cavity cores 1.

And, as the robot 5 and robot arm 50 are rotated, the cavity core 1 held by the robot hand 51 can be delivered to the respective positions where the primary molding station 2, secondary molding station 3 and die removing station 4 are disposed.

As shown in FIG. 6, the primary molding station 2 includes a first movable die 20 and a first fixed die 21, while the first movable and fixed dies 20 and 21 are fixed to mounting plates 22 and 23, respectively. A first injection cylinder 24 is in contact with one mounting plate 23; between the mounting plate 23 and first fixed die 21, there is formed a runner portion 25; and, in the first fixed die 21, there is formed a gate portion 26.

As shown in FIG. 7, the secondary station 3 includes a second movable die 30 and a second fixed die 31, while the second movable and fixed dies 30 and 31 are fixed to mounting plates 32 and 33 respectively. A second injection cylinder 34 is in contact with one mounting plate 33; between the mounting plate 33 and second fixed die 31, there is formed a sprue portion 35; and, in the second fixed die 31, there is formed a gate portion 36.

Now, description will be given below of a method for molding the molded product shown in FIGS. 1 and 2 using the above-mentioned two color resin molding apparatus according to the present embodiment.

Firstly, as shown in FIG. 6, in a state where the first movable and fixed dies 20 and 21 are opened, a cavity core 1 held by the robot hand 51 is interposed between the first movable and fixed dies 20 and 21. Into the cavity core 1, there has been previously inserted a core die 15 which is used to mold the nipple portion of the molded product.

And, when the first movable and fixed dies 20 and 21 are fastened together, as shown in FIG. 8, the cavity core 1 and core die 15 are respectively held by and between the first movable and fixed dies 20 and 21. In this state, when fused polyethylene resin is injected from the first injection cylinder 24, the fused resin passes through the runner portion 25 and gate portion 26 and fills up the first cavity 12 formed between the die surface of the first fixed die 21 and the die surface of the cavity core 1. As a result of this, there is molded the primary molding (A) in the primary molding station 2.

When the primary molding (A) is cooled to a certain degree, the first movable die 20 and core die 15 are opened, and a set of (four) projections 52 of the robot hand 51 are engaged with the hold holes 13 of the cavity core 1, whereby the cavity core 1 having the primary molding (A) is taken out from the primary molding station 2. At the then time, the other set of projections 52 of the robot hand 51 hold the empty cavity core 1 which is received in the die removing station 4. The cavity core 1 having the primary molding (A) is replaced with the empty cavity core 1. Therefore, between the first movable and fixed dies 20 and 21, there is interposed the empty cavity core 1; and, in the primary molding station 2, the next molding operation is executed. On the other hand, the cavity core 1 having the primary molding (A) is delivered to the secondary molding station 3 by the robot 5.

Now, FIG. 9 shows the cavity core 1 having the primary molding (A), with the core die 15 removed therefrom. By and between the split dies 10 and 11, there is held the primary molding (A) that has been formed in the first cavity 12.

In the secondary molding station 3, as shown in FIG. 7, in a state where the second movable and fixed dies 30 and 31 are opened, a cavity core 1 having the primary molding (A) is interposed between the second movable and fixed dies 30 and 31. Into the cavity core 1, there has been previously inserted a core die 16 which is used to mold the nipple portion of the molded product.

And, when the second movable and fixed dies 30 and 31 are fastened together, as shown in FIG. 10, the cavity core 1 having the primary molding (A) and core die 16 are respectively held by and between the second movable and fixed dies 30 and 31. In this state, when fused polyamide resin is injected from a second injection cylinder 34, the fused resin passes through the sprue portion 35 and gate portion 36 and fills up a second cavity 37 formed between the surface of the primary molding (A) and the die surface of the second fixed die 31. As a result of this, there is molded a secondary molding (B) in the secondary molding station 3.

When the secondary molding (B) is cooled to a certain degree, the second movable die 30 and core die 16 are opened, and one set of projections 52 of the robot hand 51 are engaged with the hold holes of the cavity core 1, whereby the cavity core 1 having a molded product composed of the primary molding (A) and secondary molding (B) is drawn out from the secondary molding station 3. At the then time, the other set of projections 52 of the robot hand 51 hold a cavity core 1 having a primary molding (A) drawn out from the primary molding station 2; and thus, the cavity core 1 having the molded product is replaced with the cavity core 1 having the primary molding (A). Therefore, between the second movable and fixed dies 30 and 31, there is interposed the cavity core 1 having the primary molding (A) and thus, in the secondary molding station 3, there can be carried out the next molding operation. On the other hand, the cavity core 1 having the molded product is delivered to the die removing station 4 by the robot 5.

In the die removing station 4, the two split dies 10 and 11 are split from each other to thereby remove the molded product from the cavity core 1. And, the thus emptied cavity core 1 is held again by the robot hand 51 and is delivered to the primary molding station 2. In the primary molding station 2, not only the cavity core 1 having the primary molding (A) is taken out by the robot hand 51 but also the empty cavity core 1 is disposed and the next primary molding operation can be carried out.

Thus, according to the two color resin molding apparatus of the present embodiment, there is provided a structure in which the cavity core 1 can be moved between the respective stations and, in the primary molding station 2 and secondary molding station 3, there are used different molding machines respectively, which can prevent the die structure from increasing in size or from being complicated. Therefore, the rigidity of the die can be enhanced and also the occurrence of burrs can be prevented.

Also, since the length of the runner portion of the die is prevented from increasing, the yield rate of the molding material can be enhanced. Further, it is not necessary to use a specific molding machine but it is possible to use a general-purpose molding machine simple in structure, which makes it possible to restrict the installation cost of the molding machine and thus to reduce the number of steps necessary for maintenance thereof.

And, because of use of the robot 5 including the robot hand 51 capable of holding two cavity cores 1, by using three cavity cores 1 by turns, molding and die removing operations can be executed parallel in the respective stations, thereby being able to secure high productivity.

Further, in the conventional die slide method described hereinbefore in the related art, to mold the same molded product, there is necessary a large-size die having the dimensions of about 650×1000×600 mm and the weight of 1˜2 tons. However, according to the molding apparatus of the present embodiment, each of the dies, which are used in the primary and secondary molding stations, has the dimension of about 350×400×300 mm and the weight of about 300˜350 kg, thereby being able to reduce the installation space and weight of the molding apparatus greatly.

Also, since the primary molding (A) itself is not drawn out, there is no possibility that the primary molding (A) can be unfavorably cooled, which makes it possible to secure good adhering performance between the primary molding (A) made of maleic acid denatured polyethylene and secondary molding (B) made of polyamide.

In the present embodiment 1, after the core die 15 is previously inserted into the cavity core 1, the cavity core 1 is disposed into the first movable die 20. However, this is not limitative. For example, the core die 15 may be mounted together with a cylinder on the first movable die 20 and, after the cavity core 1 is stored into the first movable die 20, the cylinder may be operated to thereby slide the core die 15 into the cavity core 1.

### Embodiment 2

Now, FIG. 11 shows a molded product produced by a two color resin molding apparatus according to the present embodiment. This molded product is a filler lower which is to be welded to the outer peripheral surface of a fuel tank, while the molded product is composed of a primary molding (A) made of maleic acid denatured polyethylene and a secondary molding (B) made of polyamide and connected integrally to the inner peripheral surface of the primary molding (A). The primary molding (A) secures the strength and rigidity of the molded product, while the secondary molding (B) secures the fuel transmission resistance of the molded product.

The present molded product is basically molded by a similar two color resin molding apparatus to the embodiment 1. Here, FIG. 12 shows a section view of a die used in the primary molding station 2, and FIG. 13 shows a section view of a die used in the secondary molding station 3. The parts of the present embodiment, which are the same in function as the parts of the embodiment 1, are given the same designations as in the embodiment 1.

In the primary molding station 2 shown in FIG. 12, a cavity core 1 is held by and between the first movable die 20 and first fixed die 21. Between the die surfaces of the first movable and fixed dies 20, 21 and the die surface of the cavity core 1, there is formed a first cavity 12 which is used to mold the primary molding (A). Therefore, in the primary molding station 2, the primary molding (A) is molded similarly to the embodiment 1, and the cavity core 1 having the primary molding (A) is delivered to the secondary molding station 3.

In the secondary molding station 3 shown in FIG. 13, the cavity core 1 having the primary molding (A) is held by and between the second movable and fixed dies 30 and 31. Between the die surfaces of the second movable and fixed dies 30, 30 and the surface of the primary molding (A), there is formed a second cavity 37 which is used to mold a secondary molding (B). Therefore, in the secondary molding station 3, the secondary molding (B) is molded similarly to the embodiment 1, the cavity core 1 having a molded product composed of the primary and secondary moldings (A) and (B) is delivered to the die removing station 4, where the molded product is removed from the die similarly to the embodiment 1.

That is, in the two color resin molding apparatus according to the present embodiment as well, there can be provided similar operations and effects to the embodiment 1.

In the above-mentioned embodiments, maleic acid denatured polyethylene and polyamide are used as molding materials, and, making use of the thermal reaction adhesion of them, the two two-color resin moldings are formed respectively. However, the two molding materials may be formed of the same kinds of resin and they may be thermally fused to be thereby connected together. In this case as well, since the primary molding is delivered together with the cavity core 1, the temperature of the primary molding can be prevented from lowering, thereby being able to secure high connecting strength.

A multicolored resin molding apparatus and a multicolor molding method according to the invention can be used in injection-molding, injection compression molding, transfer molding and the like.

What is claimed is:

1. A multicolored resin molding apparatus comprising:
a primary molding station including a first movable die and a first fixed die, and holding a cavity core having a die surface between the die surface of the movable die and the die surface of the fixed die, for molding a primary molding in a first cavity formed between at least one of the die surfaces of the first movable and fixed dies and the die surface of the cavity core;
a secondary molding station including a second movable die and a second fixed die, and holding the cavity core having the primary molding between the die surface of the second movable die and the die surface of the second fixed die, for molding a secondary molding in a second cavity formed between at least one of the die surfaces of the second movable and fixed dies; and
a die removing station for drawing out a molded product composed of the primary molding and the secondary molding from the cavity core; and
a first delivery device for delivering the cavity core having the primary molding from the first molding station to the secondary molding station;
a second delivery device for delivering the cavity core having the molded product from the secondary molding station to the die removing station; and
a third delivery device for delivering the cavity core, from which the molded product is drawn out and is thereby emptied, from the die removing station to the primary molding station.

2. A multicolored resin molding apparatus according to claim 1, wherein the first delivery device, the second delivery device and the third delivery device are composed of a robot including a hand capable of holding at least two of the cavity cores.

3. A multicolor molding method, using a multicolored resin molding apparatus according to claim 1, for molding the primary molding in the first cavity in the primary molding station, for delivering the cavity core having the primary molding from the first delivery device to the secondary molding station to mold the secondary molding in the second cavity, and for delivering the cavity core having the molded product composed of the primary and secondary moldings from the second delivery device to the die removing station to draw out the molded product from the cavity core.

4. A multicolored resin molding apparatus according to claim 1, wherein the primary molding station, the secondary molding station and the die removing station are disposed substantially on the circumference of a circle.

5. A multicolored resin molding apparatus according to claim 1, wherein maleic acid denatured polyethylene and polyamide are used as molding materials.

6. A multicolor molding method according to claim 3, wherein the primary molding station, the secondary molding station and the die removing station are disposed substantially on the circumference of a circle.

7. A multicolor molding method according to claim 3, wherein maleic acid denatured polyethylene and polyamide are used as molding materials
